(19) United States
(12) Patent Application Publication
(10) Pub. No.: US 2005/0193000 A1
(43) Pub. Date: Sep. 1, 2005

(54) Method for the processing and visualization of distributed stored data

(75) Inventor: Stefan Linke, Nuernberg (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AG

(21) Appl. No.: 11/046,704

(22) Filed: Feb. 1, 2005

Related U.S. Application Data
(63) Continuation of application No. PCT/DE03/02596, filed on Aug. 1, 2003.

(30) Foreign Application Priority Data
Aug. 1, 2002 (DE) 102 35 214.3

(51) Int. Cl. G06F 17/00

(52) U.S. Cl. 707/102

(57) ABSTRACT

A method for processing and displaying distributed stored data, where each particular data record is provided with objects (1 to 7) to be processed and displayed separately. Objects are arranged so as to be distributed within a network topology of a data processing system, such that the objects are each assigned to different or similar projects (1 to 4). A display of the network topology for processing of the data of each object and/or project is carried out such that the topology of a given project can be separately displayed and characterized as active with a separate display and processing selection field.

This is a Continuation of International Application PCT/DE2003/002596, with an international filing date of Aug. 1, 2003, which was published under PCT Article 21(2) in German, and the disclosure of which is incorporated into this application by reference.

### FIELD AND BACKGROUND OF THE INVENTION

The invention relates to a method for the processing and visualization of distributed stored data, each specific data record being assigned to objects that are to be processed and visualized separately.

Where data must be displayed and processed by the user, the data frequently originates from different storage locations. For example, the respective files may be stored on different computers, so that the user can access them only in special views, e.g., in a so-called tree representation on the screen of the corresponding computer. In other words, this processing and displaying is oriented according to the data storage location, and the user can only specify where the changed or newly generated data are ultimately stored.

In other applications, which provide other special views that are not hierarchically oriented according to the data storage location, it is not currently possible for the user to preserve the representation specific to the application, and thus, optimal for a given application case, while at the same time, controlling the storage location of the data. As a rule, prior art solutions are therefore limited to a specific type of representation, e.g., the tree representation, or require a special view depending on the data storage location. From the European Patent EP 0 314 595 B1, for example, it is known per se, to store the product data for a product design tool in a CAD/CAM environment in different data records in a relational database system of a data processing system. Here, the data of a product can be displayed and processed via an above-described tree structure using what is called a top-down design record.

### OBJECTS OF THE INVENTION

In view of the above, an object of the invention is to further develop a method for the processing and displaying of distributed stored data of the above-described type, so as to give the user simple data storage, and thereby, better control over the storage location of the data without impeding the workflow.

### SUMMARY OF THE INVENTION

According to the invention, in a method for the processing and displaying of distributed stored data, each particular data record being assigned predefined objects or projects to be processed and displayed separately, is further developed such that objects are arranged so as to be distributed within a network topology of a data processing system. The objects are each assigned to different or similar projects. According to the invention, the network topology is displayed for processing the data of each object and/or project. Using a separate display and processing selection field, the topology of a given project is separately dispalyed and identified as active at one of a plurality of user workstations within the network. The invention is particularly advantageous if the data processing system is an automation system and the objects are stations in the form of open-loop or closed-loop control blocks, or represent networks, e.g., MPI, Ethernet or the like, sources, symbol bars or generally any type of objects of an automation system. A specific project can also be displayed and activated simply by selecting a given object or station assigned to this project.

The invention can be used, in particular, in computer-controlled automation systems in which visually supported network planning is used. The proposed method is suitable, in particular, for so-called multiprojects, which are a logical aggregation of a plurality of individual automation projects and which are programmed, for example, in the programming language STEP 7. It is advantageous if the data volume provided by the many individual projects is not large and difficult to handle, but can be kept relatively small. With the logical bracket of the multiproject, the user can nevertheless be provided with a functionality that makes the individual projects within the multiproject appear as a single project from the user's perspective.

The functionality proposed according to the non-limiting embodiments of the invention provide a significant advantage to the user by making it possible to temporarily remove individual projects from the multiproject for continued processing in a standalone operation at a different location, e.g., at the site of an automation component subcontractor. In such multiprojects and the individual projects contained therein, care has to be taken, however, that the data can still be stored in a distributed manner. In other words, for each project, for example, a different storage location is possible. The storage location, however, is extremely important for the user. For instance, if several subcontractors are working on a multiproject, such that each subcontractor is responsible for a project within the multiproject, it is crucial that a subcontractor working within the scope of the multiproject, e.g., to match data across the project or at the time of commissioning, has control over where his changes are stored. In each case, it is advantageous in network planning to have a complete view of the multiproject.

### BRIEF DESCRIPTION OF THE DRAWINGS

The invention will now be described, by way of example, with reference to the non-limiting embodiments depicted in the drawings, in which:

FIG. 1 shows a schematic view of the projects of an automation system with objects or stations from different data locations and a so-called combo-box for selecting the data locations,

FIG. 2 shows a modified view with a so-called button bar to select the data storage locations, and

FIG. 3 shows a modified view according to FIG. 2 where a data storage location or project is selected by selecting an object or station.

### DETAILED DESCRIPTION OF THE PREFERRED EMBODIMENTS

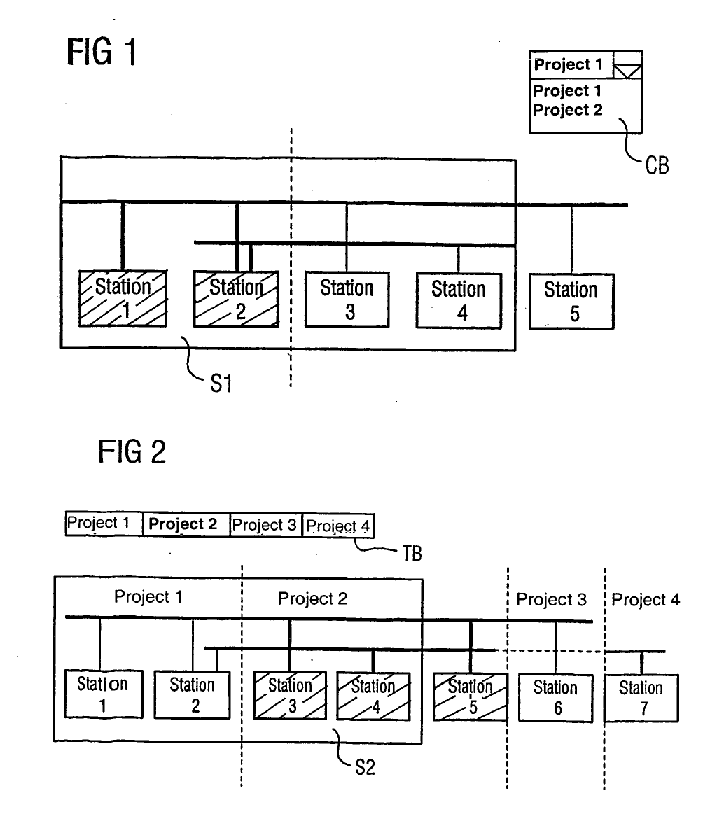

FIG. 1 shows a detail of a view of the network topology of an automation system according to a non-limiting embodiment of the invention, in which a project 1 and a project 2 are located in the visible area S1. In this representation, a combo-box CB, in which a project 1 or 2 can be selected by means of a scrollbar, is used to show which project or which data location is the current data location that is active for processing.

In the view S1 shown in FIG. 1, the objects (stations 1 and 2), which belong to the currently active data location, i.e., to the project 1, are visually separated from the stations 3-5 by the hatched line, and are highlighted by the hatching marks in each respective station. In alternate embodiments, any type of highlighting, i.e., bold lines or shading, can be used to indicate which stations are active. The stations 3 to 5, which do not belong to the project 1, are not processed through the current data location. It is possible to select any other representations, however, that show which objects belong to the currently active data storage location.

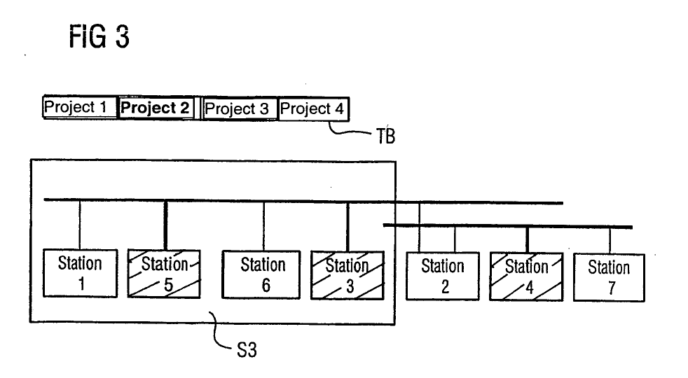

In FIG. 2, the project 2 (written in bold text) is currently the active project for the data location. Here, the means offered to switch to another project or another data location is a toolbar or a button bar TB, which has a button for each project. In the view S2, like in FIG. 1, the objects (stations 3, 4 and 5) belonging to the currently active data management for the project 2 are again separated from the remaining stations by the hatched lines, and are highlighted by the hatching marks in each respective station.

FIG. 3, which is a non-limiting modified representation according to FIG. 2, shows a mixed representation of the objects (stations 1 through 7 in mixed order) with respect to the data location or the project assignment, with a different hierarchical structure, as shown by the example view S3. The user can again use the toolbar TB to determine which data location or project is currently active and what the associated objects are. To switch from the currently active data management or project, a corresponding object (station) is simply selected. In the example shown, when the station 5 is selected, the project 2 is highlighted (bold text) as the active data management and stations 3, 4 and 5 become active and are highlighted. Here, the user could, for example, also select station 6, such that, in conformance to the allocations shown in FIG. 2, the project 3 would be displayed as active (bold text) in the toolbar TB and only station 6 would be highlighted.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

1. A method for processing and displaying distributed stored data records, each specific data record being assigned predefined objects to be processed and displayed separately, the method comprising:
arranging the objects so as to be distributed within a network topology for a data processing system;
assigning the objects to respective projects; and
in order to process the data records of the corresponding objects or projects, displaying the network topology, such that the network topology of a given project is separately displayed and identified as active using a separate display and processing selection field at a plurality of user workstations within the network, in accordance with the given project'is data storage location.

2. The method as claimed in claim 1, wherein the data processing system is an automation system and the objects comprise at least one of respective stations, networks, sources, and symbol bars of the automation system.

3. The method as claimed in claim 2, wherein the objects are open loop or closed loop control units.

4. The method as claimed in claim 1, wherein a specific project is also displayed and activated by selecting a specific object or station assigned to the specific project.

5. The method as claimed in claim 1, further comprising a plurality of projects.

6. The method as claimed in claim 1, wherein the given project is identified as active by highlighting at least one respective object of the given project.

7. The method as claimed in claim 1, wherein the given project is selected as active by selecting a corresponding button on a toolbar.

8. A software module having a computer readable medium to carry out a method as claimed in claim 1, wherein the topology of the given project within the network is displayed and activated at each user workstation.

9. A software module having a computer readable medium to carry out the method as claimed in claim 4, wherein the topology of the given project within the network is displayed and activated at each user workstation.

10. A data processing device comprising the software module as claimed in claim 8.

11. A data processing device comprising the software module as claimed in claim 9.

12. The method according to claim 1, wherein the topology of the given project is displayed and identified as active separately from remaining projects in the network topology.

13. The method according to claim 1, wherein the display and processing selection field is provided separately from the network topology.
